(19) United States
(12) Patent Application Publication
(10) Pub. No.: US 2026/0283405 A1
(43) Pub. Date: Sep. 24, 2026

(54) GRINDER FOR GRINDING A PRODUCT IN BEANS, PARTICULARLY FOR A BEVERAGE VENDING MACHINE

(71) Applicant: SAGA COFFEE S.P.A., Valbrembo (BG) (IT)

(72) Inventor: Massimo BALDO, Silea (TV) (IT)

(21) Appl. No.: 18/997,960

(22) PCT Filed: Jul. 27, 2023
(86) PCT No.: PCT/IB2023/057628

§ 371 Date: Jan. 23, 2025

(30) Foreign Application Priority Data
Jul. 29, 2022 (IT) 102022000016245

(51) Int. Cl. A47J 42/40; A47J 42/46

(52) U.S. Cl. CPC A47J 42/40; A47J 42/46

(57) ABSTRACT

A grinding apparatus has a grinder driven by an electric motor-for moving a ground product through an outlet and a measuring device- for measuring the amount of ground product flowing through the outlet; the measuring device having a guide channel communicating with the outlet and configured to form and move a uniform flow of ground product in a supply direction and a measuring wheel-partially housed in the channel to cooperate, in use, with the flow, of ground-product; the wheel As being able to rotate freely inside the channel around a hinge axis-orthogonal to the supply direction and an electronic sensory system detects the angular position of the wheel around the axis and outputs an electric signal that allows the electronic control unit-to calculate the angular movement of the wheel around the axis and, based thereon, calculate the amount of ground product flowing along the channel towards the outlet.

### CROSS-REFERENCE TO RELATED APPLICATIONS

This Patent Application claims priority from Italian Patent Application No. 102022000016245 filed on Jul. 29, 2022, the entire disclosure of which is incorporated herein by reference.

### TECHNICAL FIELD OF THE INVENTION

This invention relates to a grinder for grinding a product in beans, particularly for a beverage vending machine.

### PRIOR ART

In the field of machines for preparing beverages, in general, and coffee in particular, to which the following description will refer without losing generality, it is known to use a grinding and dosing apparatus comprising a grinder, which receives a flow of coffee beans, and dispenses a flow of ground coffee with a predefined grain size that can be chosen according to the type of beverage to be prepared.

In some applications, in particular in the world of vending, the grinding and dosing apparatus further comprises a volumetric doser, which receives the flow of ground coffee from the grinder and doses it before sending it to a beverage preparation unit, such as, for example, a brewing assembly.

Generally, the doser comprises a dosing chamber, which has a constant and predefined volume depending on the quantity of ground coffee required for the preparation of a beverage and is progressively filled until it is completely full, after which it is emptied by opening a discharge opening, through which the ground coffee is discharged into the beverage preparation unit.

Although commonly used, the known volumetric dosers of the type described above are not completely satisfactory since they do not ensure precise dosing and, above all, consistent dosing over time. This imprecision derives from the fact that the dosing fails to take account of the changes in the coarseness of the ground coffee as a result of the inevitable wear of the grinder and requires, therefore, periodic calibration by a specialised technician in order to limit the change in the dose of ground coffee dispensed by the doser.

Another cause of imprecision derives from the fact that, inevitably, a part of the ground coffee progressively thickens near or around the inlet and discharge openings of the dosing chamber, hindering the normal flow and the expected movement of the mobile walls for the opening/closing of the inlet and discharge openings. The presence of agglomerates of ground coffee inside the chamber-the more powdery the ground coffee is and the more sensitive it is to humidity, the more agglomerates there are-risks misrepresenting the amount of ground coffee dispensed by the dosing chamber both as less than, if part of the ground coffee cannot leave the dosing chamber, and as more than, if, together with the amount of ground coffee in the dosing chamber, an additional amount of ground coffee not dispensed in the previous dosings, which remained thickened around the chamber openings, is dispensed.

In addition to this, the volumetric dosers are normally not very flexible, i.e., they are not suitable for being quickly adapted to dispense partial doses or, in any case, different from a multiple of the amount that can be coOntained in the dosing chamber.

In other applications, typically in the sector of home coffee machines or in the hospitality industry, volumetric dosers are not used and the ground product is dosed based on the operation time of the grinder or on the number of revolutions of the grinder rotor. In these cases, then, the amount of ground coffee for the preparation of a beverage to be dispensed is determined indirectly, i.e., it is estimated based on an operation time of the grinder or a number of expected revolutions of the grinder rotor.

This method, though it enables simple, continuous, and practically immediate changes to the quantity of ground coffee required for beverages, even different ones, is critical in some situations, not at all infrequent, including that involving an inconstant flow of coffee beans delivered to the grinder or even the total lack of coffee beans in the supply hopper of the grinder.

In these cases, the expected amount of ground coffee is, theoretically, dispensed while, in practice, it is partial or even zero.

To avoid this issue, the counting of the number of revolutions of the grinder drive motor is combined with checking the current absorbed by the same. If, on the one hand, this association makes it possible to detect discontinuity or absence of coffee beans supplied to the grinder, which is signalled by an oscillation or rapid reduction in the current absorbed by the grinder motor, on the other hand, it does not enable improvements in the precision of the dosing of the ground coffee since a change in the current absorbed by the grinder motor is in any case detected later than when the discontinuity actually occurs, so that at least part of the dosings are carried out with less ground coffee.

Association of two measuring devices for measuring the current absorption and the number of revolutions of the grinder motor also has the drawback of increasing, on the one hand, the production costs of the grinding and dosing apparatus and requires, on the other hand, frequent and periodic maintenance and control operations to ensure the expected efficiency of the two measuring devices and the synergy between the same.

US 2017/231419 A1 discloses a grinder for preparing powdered brewing materials comprising a main casing, a grinding assembly and an unloading assembly to measure the amount of the brewing powder to unload. The unloading assembly has an unloading motor and a measuring barrel. When the user puts the brewing materials into the main casing, the grinding assembly grinds the brewing materials into the brewing powder. The brewing powder drops into the unloading assembly. When the unloading motor actuates the measuring barrel rotates, the brewing powder is deposited in a filter. Therefore, a user can grind tea leaves, Chinese herbal medicine, the petals and so on to have fresh brewing powder. Brewing liquids with the fresh brewing powder keeps the nutrient content and flavour. In addition, the bags for packaging the brewing powder is no longer needed to reduce environmental pollution and packaging cost.

US 2013/091802 A1 discloses a coffee filter pouch maker comprising a bean hopper that gravity feeds into an electric bean grinder that ejects grounds into a hopper. A precise manual portioner delivers by gravity feed a predetermined amount of grounds into a filter pouch. Filter pouched are provided on a perforated roll of filter pouches. The filter pouches are sealable. A roll of impermeable bag segments is provided to hold one or more prepared filter pouches. The impermeable bags are vacuumed and sealed with an integrated vac/seal assembly.

### SUBJECT AND SUMMARY OF THE INVENTION

The purpose of the present invention is to provide a grinder for grinding a product in beans, which makes it possible to overcome the above-described drawbacks.

According to this invention, a grinder for grinding a product in beans, particularly for a beverage vending machine, is provided, as claimed in the appended claims.

### BRIEF DESCRIPTION OF THE DRAWINGS

The invention will now be described with reference to the attached drawings that illustrate a non-limiting embodiment thereof, in which:

FIG. 1 schematically illustrates, in a perspective view and lateral elevation, a grinder according to the present invention in a coffee beverage preparation machine schematically and partially illustrated;

FIG. 2 is a cross-section of the grinder shown in FIG. 1; and

FIG. 3 illustrates, in a perspective view and on a greatly enlarged scale, a detail of FIG. 1.

### DETAILED DESCRIPTION OF PREFERRED EMBODIMENTS OF THE INVENTION

This invention will now be described in detail with reference to the figures attached to enable a person skilled in the art to produce it and use it. Various modifications to the described embodiments will be readily apparent to those skilled in the art and the general principles described may be applied to other embodiments and applications without however departing from the protective scope of this invention as defined in the appended claims. Therefore, this invention should not be regarded as limited to the embodiments described and illustrated herein, but should be allowed the broadest protection scope consistent with the features described and claimed herein.

Unless otherwise defined, all technical and scientific terms used herein have the same meaning commonly understood by one of ordinary skill in the art to which the invention belongs. In case of conflict, the present specification, including the definitions provided, will control. In addition, the examples are provided purely for illustrative purposes and, as such, must not be considered as limiting.

In order to facilitate understanding of the embodiments described herein, reference will be made to some specific embodiments and a specific language will be used to describe the same. The terminology used herein is used for the purpose of describing particular embodiments only, and is not intended to limit the scope of the present invention.

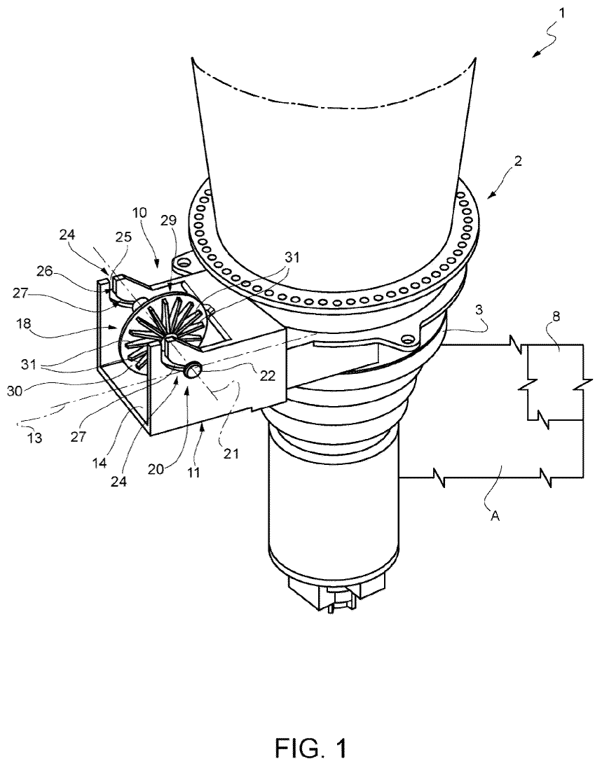

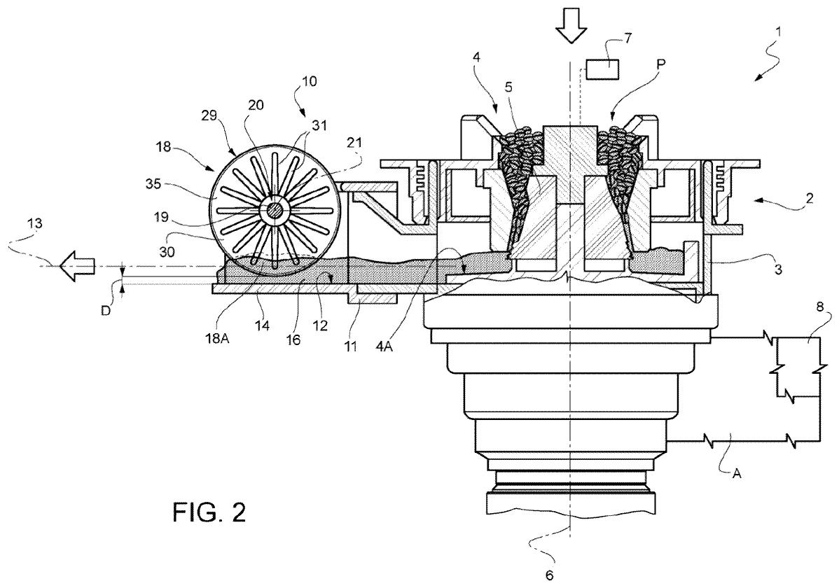

In FIGS. 1 and 2, reference numeral 1 references, as a whole, a grinding apparatus for grinding a product P in beans (FIG. 2), for example coffee, which apparatus is preferably, but not exclusively, applicable in a coffee beverage preparation machine A that is known per se and partially illustrated.

The grinding apparatus 1 comprises a grinder 2 known per se and comprising an attachment frame 3, an inlet 4 for the product P to be ground, an outlet 4A for the ground product P, and a movable grinding member 5 for grinding the product P in beans.

The movable grinding member 5 is mounted to rotate about a fixed axis 6 under the thrust of an electric motor 7 controlled by an electronic control unit 8 of the coffee beverage preparation machine A.

The grinding apparatus 1 further comprises a measuring device 10 for measuring the amount of ground product flowing through the outlet 4A and enabling the dosing of the ground product in predefined portions to obtain corresponding coffee beverages.

With reference to FIG. 2, the measuring device 10 comprises a frame 11, which is coupled and permanently connected to the frame 3 at the outlet 4A and delimits a channel 12 extending in a direction 13 orthogonal to the fixed axis 6.

The channel 12 has a rectangular cross-section and comprises a bottom wall 14 that is transverse to the axis 6 and two side walls 15 that face each other and project upwards from the bottom wall 14. The bottom wall 14 can be perpendicular to the axis 6 or inclined to encourage the discharge of the ground product.

The channel 12 has an inlet that communicates with the outlet 4A to receive the ground product from the grinder 2 and is configured to form and move a continuous flow 16 of ground product in a supply or evacuation direction coinciding with the direction 13 and directly towards a known beverage production unit not shown in the Figures.

With reference to FIG. 2, the measuring device 10 further comprises a measuring wheel 18 arranged inside the channel 12 to cooperate with the flow 16 of ground product.

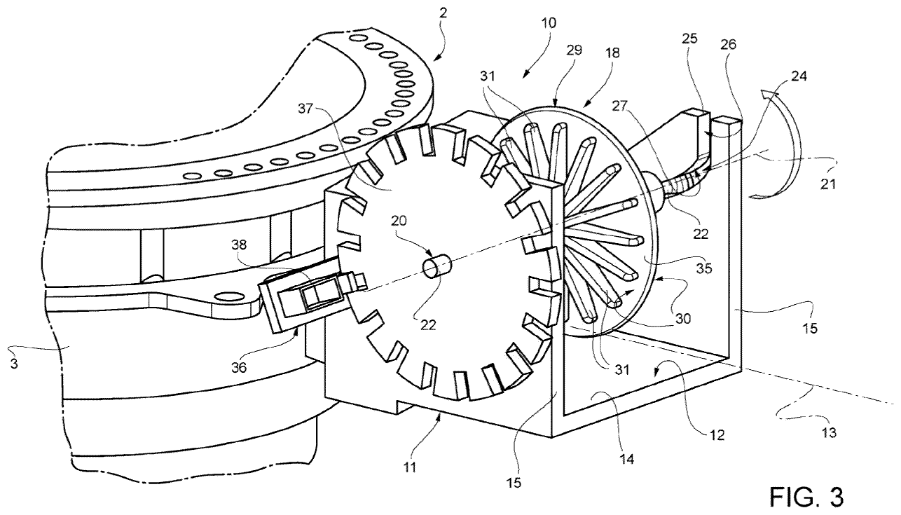

With reference to FIG. 2 and, in particular, to FIG. 3, the wheel 18 is keyed to an intermediate portion 19 of a hinge shaft 20, which has an axis 21, which is orthogonal to the direction 13 and to the axis 6 and parallel to the bottom wall 14, and two opposite end portions 22. The wheel 18 is delimited on the outside by a circular perimeter surface 29 and is mounted, in relation to the channel 12, so that said perimeter surface 29 is arranged at a minimum distance D from the bottom wall 14.

In the example shown in FIG. 1, each portion 22 extends through a corresponding wall 15 and rotatably and slidably engages an associated shaped guiding slit 24 formed through the corresponding side wall 15.

In the example described, each slit 24 has an opening 25 open upwards for the access and insertion of the corresponding portion 22 and, starting from the corresponding opening 25, a section 26 that is basically vertical and orthogonal to the bottom wall 14, and a section 27 inclined with respect to the supply direction 13 and, preferably, curved, which has a concavity turned upwards and ending, below, with a stop or end-of-stroke surface, against which the corresponding portion 22 rests.

The configuration of the slits 24 is chosen so as to enable a free and continuous movement of the shaft 20 along a predefined distancing path that allows the wheel 18 to move away from the bottom wall 14 so that the wheel 18 can be arranged in multiple operating positions under the thrust of the ground product alone.

In a different embodiment, the portions 22 of the wheel 18 are assembled on corresponding side walls 15 in an axially fixed position so that the distance of the perimeter surface 29 from the bottom wall 14 is always constant.

With reference to the attached Figures, the wheel 18 is delimited by two opposite front surfaces 30 that are orthogonal to the axis 21; each front surface 30 carries a set of radial ribs, referenced with 31, which cantilevers parallel to the axis 21 from the corresponding front surface 30.

In the example shown, the ribs 31 are equal in size and configuration and each of them has a dimension measured parallel to the axis 21 that increases from the periphery to the axis 21. Each rib 31 preferably ends towards the perimeter surface 29 with an end section, which is radially withdrawn from the perimeter surface 29 so as to leave free an external annular portion 35 of the corresponding front surface 30 from ribs, as can be seen in FIGS. 2 and 3.

In a different embodiment, the ribs 31 may have different sizes and configurations. With reference to FIG. 3, the measuring device 10 comprises, finally, an electronic sensory system 36 designed to sense the angular portion of the wheel 18 around the axis 21 and output an electric signal that enables the electronic control unit 8 to compute the angular movement of the wheel 18 around the axis 21 and, based on the computed angular movement, the amount of ground product flowing along the channel 12 towards the outlet 4A. The electronic control unit 8 is preferably programmed to control the operation of the electric motor 7 of the grinder 2 based on the computed amount of product.

Conveniently, the electronic sensory system 36 comprises a phonic wheel 37 keyed to one of the end portions 22 of the shaft 20 and a sensor 38 associated with the phonic wheel 37 and connected to the electronic control unit 8 of the coffee beverage preparation machine A.

The phonic wheel 37 can be of any known type that fits for the purpose, for example, a magnetic-inductive one or an optical (encoder) one or a capacitive one. The sensor 38, which may be of the electromagnetic or Hall effect type or a return optical sensor depending on the type of phonic wheel used, is arranged facing a toothed edge of the wheel 18 to detect the passage of the teeth of the wheel 18 and output an impulse electrical signal with a frequency indicative of the rotation speed of the phonic wheel 37.

In use, the ground product flowing out of the grinder 2 through the outlet 4A enters and moves forward in the channel 12 forming the flow 16 of ground product, which, irrespective of the beverage to be prepared and, thus, of the quantity of ground product required, has an almost constant cross-section and a thickness that is always greater than the minimum distance D. In this way, as can be seen in FIG. 2, a perimeter portion 18A of the wheel 18 is always inserted in the flow 16 of ground product that, therefore, rotates the wheel 18 around the axis 21.

The dragging of the wheel 18 is ensured by the ribs 31, whose peripheral end segments penetrate inside the same flow 16 and are intercepted by the flow 16 of ground product coming out. The impact between the flow 16 of ground product and the ribs 31 advantageously produces, in addition, the breaking or breakdown of any lumps or agglomerates of ground product present around the wheel 18.

The rotation speed of the wheel 18 is measured by the electronic sensory system 36 and a corresponding signal is transmitted to the electronic unit 8, which, being known the quantity of ground product required to produce the requested beverage and the ratio between the quantity of ground product that is fed to the outlet of the channel 12 per impulse of the signal outputted by the sensor 38, stops the electric motor 7 as soon as the amount of ground product required to produce the requested beverage has flown through the outlet of the channel 12.

It seems, instead, clear that no signal is emitted when the flow of ground product is below a minimum threshold or is absent. In this case, the wheel 18 while being arranged in its lower, end-stroke position no longer comes into contact with the ground product and the consequent lack of rotation in the wheel 8 is sensed by the unit 8 that immediately generates a beverage dispensing stop signal.

The presence and shape of the slits 24 enable, instead, the wheel 18 to freely raise from the bottom wall 14 when the thickness of the flow 16 of the ground product changes, so as to avoid the formation of a barrier that would block the supply of the ground product, but without the conditions for engaging the wheel 18 with the ground product being changed. In any case, the shape of the slits 24 must be such that the movement of the wheel 18 with respect to the bottom wall 14 remains within the limits that make it possible to maintain accurate control of the amount of ground product that flows in the channel 12 and, in addition, that ensures the continuity of the connection between the sensor 38 and the phonic wheel 37.

From the above, it is clear that the device 10 allows, on the one hand, the extremely precise measurement of the quantity of ground product transiting in the channel 12 and, thus, the precise dosing of the ground product producing beverages that have all the same characteristics.

On the other hand, the device 10 enables the arbitrary change in very little time of the quantity of ground product expected to produce different beverages without the need to make configuration or structural changes.

From the above, then, it also seems clear that the particular production features of the channel 16, wheel 18, and coupling of the same wheel 18 avoid any jamming of the ground product moved forward as well as the formation of agglomerates that are mainly responsible for generating errors, dosing problems, and consequent changes in the quality of the beverage dispensed.

The inclusion of slits 24 that are open upwards eases and minimises the time for the normal cleaning and control operations.

From the above, it also seems clear that the assembly 1 described can be modified, or variants thereof produced, without departing from the protective scope defined by the claims.

In particular, the wheel 18 could be made differently from that described, by way of example, or coupled to the channel differently to how indicated, but always with the goal of ensuring the maximum fluidity and uniformity of the ground product's forward movement. For example, instead of a single wheel, two wheels arranged in parallel could be used.

In addition, the wheel 18 could be coupled to the walls 30 in a different way to that indicated, again to be moved from and towards the bottom wall 14 in a continuous way, or in a discrete way between the above-mentioned lower, end-stop position or minimum distance from the bottom wall 14 and at least one raised position in which it is placed at a distance from the bottom wall 14 that is greater than the above-mentioned minimum distance.

The grinding apparatus 1 described has, in addition, the additional advantage of being easily applied to the grinding apparatus already provided with conventional dosing systems as well, in particular those based on the numerical control of rotations of the grinder motor, in order to obtain better dosing precision.

Additional advantages consist in the construction simplicity and, thus, reduction in production costs, in the ease of cleaning thanks to less clogging of powder in the components, and in the ease of dosing auto-adjustment based on the coffee previously dispensed calculating the data of the pump, volumetric doser, and mechanism effort of the brewing assembly. For example, if the coffee is dispensed in a time of 10 sec and a flow of 4 grams per second, the software can adapt by calibrating the following coffee by adding or decreasing the quantity of ground product to be dispensed to change the parameters previously obtained.

1. A grinding apparatus for grinding a product in beans, for a beverage vending machine, the grinding apparatus comprising;
a grinder with an attachment frame, an inlet for a product in beans to be ground, a movable grinding member for grinding the product in beans;
an electric driving motor for driving the movable grinding member;
an outlet for a ground product; and
a doing device for dosing an amount of ground product supplied by the grinding apparatus;
wherein the dosing device comprise a measuring device comprising a guide channel communicating with said outlet and configured to form and advance a uniform flow of ground product in a supply direction, and at least one wheel partially housed in said guide channel and coupled to said attachment frame to freely rotate about an hinge axis transverse to said supply direction under the thrust of said ground product flow;
wherein the measuring device further comprises an electronic sensory system for sensing, and outputting an output signal indicative of, an angular position of the wheel about said hinge axis during the flow of the ground product so as to allow an electronic control unit to compute the amount of ground product flowing through said outlet based on said output signal.

2. The grinding apparatus of claim 1, wherein the electric driving motor for driving the movable grinding member-is controlled by the electronic control unit based on the output signal outputted by the electronic sensory system.

3. The grinding apparatus of claim 1, wherein the electronic sensory system comprises a phonic wheel keyed to a shaft of the at least one wheel and a sensor associated to the phonic wheel and connected to the electronic control unit.

4. The grinding apparatus of claim 1, wherein said guide channel has a bottom wall-and wherein said least one wheel is delimited externally by a perimeter surface coaxial to the hinge axis and spaced from said bottom wall.

5. The grinding apparatus of claim 4, wherein said at least one wheel carries a plurality of radial ribs extending radially starting from said hinge axis.

6. The grinding apparatus of claim 5, wherein said wheel has two opposite front surfaces orthogonal to said hinge axis; each of said front surfaces carrying a relative group of said radial ribs axially cantilevering from the respective front surfaces.

7. The grinding apparatus of claim 5, wherein each of said radial ribshas a size, measured parallel to said hinge axis, which increases towards said hinge axis.

8. The grinding apparatus of claim 4, wherein said hinge axis is movable with respect to said bottom wall between a lowered, end of stroke position, in which the at least one wheel is arranged at a minimum distance from said bottom wall, and at least one raised position in which the at least one wheel is arranged at a distance from said bottom wall greater than said minimum distance.

9. The grinding apparatus of claim 8, further comprising a guide to continuously guide said hinge axis along a distancing path that allows said wheel to move away from said bottom wall.

10. The grinding apparatus of claim 9, wherein said distancing path comprises at least one inclined section relative to said supply direction.
